(19) United States
(12) Patent Application Publication
(10) Pub. No.: US 2026/0239486 A1
(43) Pub. Date: Aug. 13, 2026

(54) SPATIAL AND POWER DOMAIN ENERGY SAVING

(71) Applicant: Nokia Technologies Oy, Espoo (FI)

(72) Inventors: Naizheng ZHENG, Beijing (CN); Chunli WU, Beijing (CN); Lei DU, Beijing (CN)

(21) Appl. No.: 19/155,884

(22) PCT Filed: Feb. 16, 2023
(86) PCT No.: PCT/CN2023/076564

§ 371 Date: Aug. 12, 2025

(51) Int. Cl. H04W 76/28; H04W 52/02

(52) U.S. Cl. CPC H04W 76/28; H04W 52/0206

(57) ABSTRACT

Embodiments of the present disclosure relate to devices, methods, apparatuses and computer readable storage media of spatial and power domain energy saving. The method comprises obtaining, from a second apparatus, an association of different Discontinuous Transmission (DTX)/Discontinuous Reception (DRX) patterns of the second apparatus with at least one of the following: one or more DRX patterns of the first apparatus, one or more energy saving modes of the second apparatus, one or more adaptation parameters of spatial domain, one or more adaptation parameters of power domain, one or more Channel State Information (CSI) report configuration, one or more measurement relaxations of the first apparatus, or one or more transmission or reception properties for channels and signals; and communicating with the second apparatus based on the association.

### FIELD

Embodiments of the present disclosure generally relate to the field of telecommunication and in particular to devices, methods, apparatuses and computer readable storage media of spatial and power domain energy saving.

### BACKGROUND

Energy consumption in 5th Generation Mobile Communication Technology (5G) new radio (NR) has been studied in the past few years, especially for the Radio Access Network (RAN), which may consume quite large part of the total energy consumption in the 5G network. As one of the key points for the topic of energy consumption, the network energy saving(ES) in time, frequency, spatial/antenna, and power domain has been discussed.

### SUMMARY

In general, example embodiments of the present disclosure provide a solution of spatial and power domain energy saving.

In a first aspect, there is provided an apparatus. The apparatus includes at least one processor; and at least one memory storing instructions that, when executed by the at least one processor, cause the apparatus at least to perform: obtaining, from a second apparatus, an association of different Discontinuous Transmission (DTX)/Discontinuous Reception (DRX) patterns of the second apparatus with at least one of the following: one or more DRX patterns of the first apparatus, one or more energy saving modes of the second apparatus, one or more adaptation parameters of spatial domain, one or more adaptation parameters of power domain, one or more Channel State Information (CSI) report configuration, one or more measurement relaxations of the first apparatus, or one or more transmission or reception properties for channels and signals; and communicating with the second apparatus based on the association.

In a second aspect, there is provided an apparatus. The apparatus includes at least one processor; and at least one memory storing instructions that, when executed by the at least one processor, cause the apparatus at least to perform: transmitting, to a first apparatus, an association of different DTX/DRX patterns of the second apparatus with at least one of the following: one or more DRX patterns of the first apparatus, one or more energy saving modes of the second apparatus, one or more adaptation parameters of spatial domain, one or more adaptation parameters of power domain, one or more CSI report configuration, one or more measurement relaxations of the first apparatus, or one or more transmission or reception properties for channels and signals.

In a third aspect, there is provide a method. The method comprises obtaining, at a first apparatus and from a second apparatus, an association of different DTX/DRX patterns of the second apparatus with at least one of the following: one or more DRX patterns of the first apparatus, one or more energy saving modes of the second apparatus, one or more adaptation parameters of spatial domain, one or more adaptation parameters of power domain, one or more CSI report configuration, one or more measurement relaxations of the first apparatus, or one or more transmission or reception properties for channels and signals; and communicating with the second apparatus based on the association.

In a fourth aspect, there is provide a method. The method comprises transmitting, from a second apparatus and to a first apparatus, an association of different DTX/DRX patterns of the second apparatus with at least one of the following: one or more DRX patterns of the first apparatus, one or more energy saving modes of the second apparatus, one or more adaptation parameters of spatial domain, one or more adaptation parameters of power domain, one or more CSI report configuration, one or more measurement relaxations of the first apparatus, or one or more transmission or reception properties for channels and signals.

In a fifth aspect, there is provided an apparatus comprising means for obtaining, from a second apparatus, an association of different DTX/DRX patterns of the second apparatus with at least one of the following: one or more DRX patterns of the apparatus, one or more energy saving modes of the second apparatus, one or more adaptation parameters of spatial domain, one or more adaptation parameters of power domain, one or more CSI report configuration, one or more measurement relaxations of the apparatus, or one or more transmission or reception properties for channels and signals; and means for communicating with the second apparatus based on the association.

In a sixth aspect, there is provided an apparatus comprising means for transmitting, to a first apparatus, an association of different DTX/DRX patterns of the apparatus with at least one of the following: one or more DRX patterns of the first apparatus, one or more energy saving modes of the apparatus, one or more adaptation parameters of spatial domain, one or more adaptation parameters of power domain, one or more CSI report configuration, one or more measurement relaxations of the first apparatus, or one or more transmission or reception properties for channels and signals.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of spatial and power domain energy saving according to some example embodiments of the present disclosure;

FIG. 3 shows examples for antenna port muting patterns according to some example embodiments of the present disclosure;

FIG. 4 shows a flowchart of an example method of spatial and power domain energy saving according to some example embodiments of the present disclosure;

FIG. 5 shows a flowchart of an example method of spatial and power domain energy saving according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “a example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

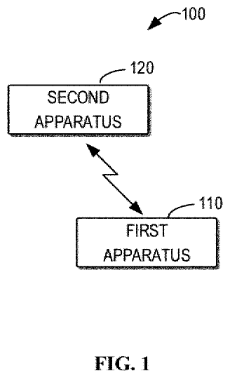

FIG. 1 shows an example communication network 100 in which embodiments of the present disclosure may be implemented. As shown in FIG. 1, the communication network 100 may include a first apparatus 110. Hereinafter the first apparatus 110 may also be referred to as a UE or a terminal device.

The communication network 100 may further include a second apparatus 120. Hereinafter the second apparatus 120 may also be referred to as a gNB or a network device. The first apparatus 110 may communicate with the second apparatus 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the second apparatus 120 to the first apparatus 110 may be referred to as a downlink (DL), while links from the first apparatus 110 to the second apparatus 120 may be referred to as an uplink (UL). In DL, the second apparatus 120 is a transmitting (TX) device (or a transmitter) and the first apparatus 110 is a receiving (RX) device (or receiver). In UL, the first apparatus 110 is a TX device (or transmitter) and the second apparatus 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

One of the key points in 5G NR may focus on energy consumption, especially for the RAN, which may consume quite large part of the total energy consumption in the 5G network. For example, the solutions for network energy savings in 5G has been studied. The study may aim at identifying network energy saving techniques in time, frequency, spatial, and power domains targeting both transmissions and receptions.

For the topic of network energy saving in spatial and power domains, the enhancements on CSI and beam management related procedures including measurement and report and signalling to enable efficient adaptation of spatial elements has been discussed.

Furthermore, another topic of network energy saving is enhancement on cell DTX/DRX mechanism including the alignment of cell DTX/DRX and UE DRX in a Radio Resource Control (RRC) connected (RRC_CONNECTED) mode.

In spatial domain, the 5G NR provides improved average user/cell throughput and service quality with one of the solutions being the usage of antenna arrays having a large number of antenna elements, which may be called as Massive Multiple Input Multiple Output (MIMO). The power consumption of a massive MIMO BS may be determined by the hardware that drive the high number of antenna ports and elements.

The power consumption may scale with the applied hardware, i.e., the numbers of transceiver chains with power amplifiers (PAS) applied, as well as the baseband processing power scales with the number of active antennas. Practically, significant energy can be saved for the massive MIMO BS by using only a subset of the available BS antennas and/or transceiver modules, i.e., switching off certain transceiver chains.

Due to the reason of large antenna activation delays in hardware, the antenna array muting and/or MIMO layer adaptation operate at rather large time scale. For example, the maximum number of DL MIMO layers can be configured per Bandwidth Part (BWP) via semi-static RRC signalling for the energy saving.

Furthermore, for spatial/antenna-domain power saving schemes, one may consider reducing the number of antenna elements per physical antenna array, while keeping the number of antenna ports or logical antenna array unchanged.

As another approach for spatial/antenna domain power saving, one may reduce the number of antenna ports for power saving, where the network may switch-off a certain number of transceiver chains, especially at low load. This approach may achieve even better power saving gain compared with elements reduction per physical antenna array. When considering the cell coverage, the performance impact can be higher for Frequency Range 2 (FR2) than Frequency Range 1 (FR1) by using this approach. Practically, the gNB may adapt the number of transceiver chains to serve UEs, e.g., in terms of UE location (cell edge or cell centre), or in terms of guaranteed data rate. From specifications perspective, the dynamic antenna port muting at network side may result in Transmit and Receive (TRX) configuration variation, and potentially with UE beam selection impact.

Regarding DTX/DRX, generally for a RRC connected mode UE configured with connected mode DRX (C-DRX), the UE is configured with a ON duration within a C-DRX cycle. In practice, the gNB usually configures the same C-DRX cycle among UEs and distribute of ON durations to different UEs in time domain. From the gNB's perspective, the C-DRX may achieve network energy savings if the gNB can always align the OFF periods for all UEs at the same time.

In Rel-16, the wake-up signal was introduced along with DCI format 2_6, it is used either to wake up UEs with PDCCH monitoring for a coming ON duration, or cancelling the PDCCH monitoring of coming durations, depend on whether or not there is traffic arriving associate with UEs. In such scenario, the gNB may need to wake up multiple times for the non-contiguous ON durations, which introduces additional transition energy to switch between ON and OFF at the gNB side. Hence, aligning transmissions/reception to the UEs in the cell within a common active time facilitates network energy saving.

Therefore, the cell-specific DTX and DRX may be considered and further developed. Specifically, the UE behaviour corresponding to different cell DTX/DRX pattern configurations may need to be explored, especially when the network power saving is applied. Moreover, considering that spatial domain adaptation and power domain adaptation is being considered at the network side, it is to be expected that different spatial/power-domain adaptations can be considered jointly with different DRX/DTX configurations.

According to some example embodiments of the present disclosure, there is provided a solution for spatial and power domain energy saving.

Example embodiments of the present disclosure will be described in detail below with reference to the accompanying drawings.

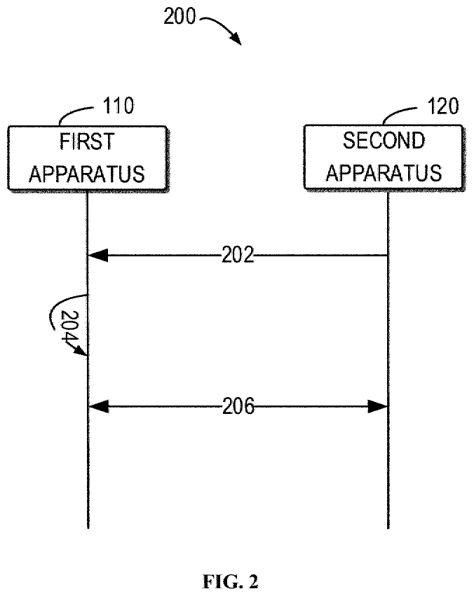

Reference is now made to FIG. 2, which shows a signaling chart 200 for communication according to some example embodiments of the present disclosure. As shown in FIG. 2, the signaling chart 200 involves a first apparatus 110 and a second apparatus 120. For the purpose of discussion, reference is made to FIG. 1 to describe the signaling chart 200. Although a single first apparatus 110 is illustrated in FIG. 2, it would be appreciated that there may be a plurality of first apparatuses performing similar operations as described with respect to the first apparatus 110 below.

The second apparatus 120 may configure different DTX/DRX patterns, which may also be referred as cell specific DTX/DRX patterns. The second apparatus 120 may indicate to the first apparatus 110 the different DTX/DRX patterns.

The different DTX/DRX patterns may be associated with one or more parameters for transmissions or receptions of the first apparatus 110 and/or second apparatus 120. For example, the association between the different DTX/DRX patterns and the one or more parameters may be configured by the second apparatus 120 and transmitted (202) from the second apparatus 120 to the first apparatus 110. The first apparatus 110 may determine (204) the one or more parameters for transmissions or receptions of the first apparatus 110 and/or second apparatus 120 based on the association and the cell specific DTX/DRX pattern used by the second apparatus 120 and communicate (206) with the second apparatus 120 by using the determined one or more parameters for transmissions or receptions of the first apparatus 110 and/or second apparatus 120, to achieve the corresponding network power saving.

As another option, the association between the different DTX/DRX patterns and the one or more parameters may also be pre-defined in specification or pre-configured by the second apparatus 120. Examples of the one or more parameters will be described in detail below.

In some example embodiments, each of the different DTX/DRX patterns may be associated with at least one DRX pattern of the first apparatus 110.

For example, the second apparatus 120 may configure different sets of DRX configurations of the first apparatus 110 for different cell specific DTX/DRX patterns, and the first apparatus 110 may apply the corresponding one depending on which cell specific DTX/DRX pattern is currently used by the second apparatus 120. That is, when the first apparatus 110 is informed that a cell specific DTX/DRX pattern is used by the second apparatus 120, the first apparatus 110 may determine a corresponding set of DRX configurations (e.g., DRX pattern) to be used by the first apparatus 110 based on the association.

In some example embodiments, each of the different DTX/DRX patterns may be associated with at least one adaptation parameter of spatial or power domain.

For example, the at least one adaptation parameter of spatial domain may refer to the number of antenna ports, which may comprise physical antenna ports or logical antenna ports, the number of Transmit Receive Units (TxRUs), the number of antenna elements/subarray or antenna panels and/or the number of transmission and reception points (TRPs).

For example, the at least one adaptation parameter of power domain may refer to a transmission power offset between Physical Downlink Shared Channel (PDSCH) and Channel State Information-Reference Signal (CSI-RS), which may be called as “powercontrolOffset”. The at least one adaptation parameter of power domain may also refer to a transmission power offset between CSI-RS and Synchronization Signal Block (SSB), which may be called as “powercontrolOffsetSS”.

In some example embodiments, each of the different DTX/DRX patterns may be associated with at least one network energy saving mode.

As an option, the network energy saving mode may refer to logical and/or physical antenna port/element muting pattern of the second apparatus 120. For example, in a case where the first apparatus 110 closes to the network device, or the traffic/cell load is low, the capacity by utilizing the higher number of antennas is not fully exploited. From the network energy saving perspective, the second apparatus 120 may switch-off parts of the transceivers for better energy efficiency, without much of the service impact to the first apparatus 110. That is, some antenna ports/elements/subarrays in the antenna pattern may be turned off.

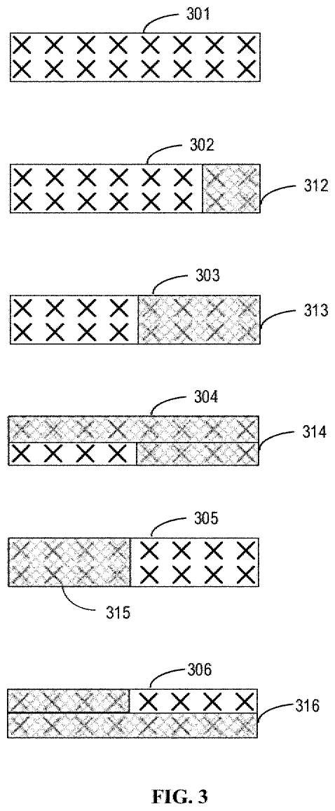

Multiple antenna/spatial patterns are shown in FIG. 3. As shown, there is no muted antenna/spatial elements in the antenna panel 301. From antenna panels 302-306, each may have a region within which the antenna/spatial elements are muted. For example, in the antenna panel 302, the antenna/spatial elements within the region 312 are muted. With different antenna/spatial elements are muted, there are different antenna/spatial patterns deployed at the second apparatus 120.

As another option, the network energy saving mode may refer to different sleep modes of the second apparatus 120, which may be called as the deep sleep mode, a light sleep mode and a micro sleep mode.

The second apparatus 120 with the deep sleep mode may be configured with a DTX/DRX of much longer non-active/OFF period, where the second apparatus 120 is expected to turn off all transmission and reception for data traffic and reference signal during cell specific DTX/DRX non-active periods.

The second apparatus 120 with the light sleep mode may be configured with a DTX/DRX of shorter non-active/OFF period, where the second apparatus 120 is expected to turn off its transmission/reception only for data traffic during cell specific DTX/DRX non-active periods, but the second apparatus 120 may still transmit/receive reference signals.

The second apparatus 120 with the micro sleep mode may perform very fast symbol-level ON and OFF, where the second apparatus 120 is expected to turn off its dynamic data transmission/reception during cell specific DTX/DRX non-active periods, but the second apparatus 120 is expected to still perform transmission/reception in periodic resources, including Semi-persist Scheduling (SPS), Configured Grant-Physical Uplink Shared Channel (CG-PUSCH), Scheduling Request (SR), Random Access Channel (RACH), and reference signals like Sounding Reference Signal (SRS).

Optionally or alternatively, the different cell specific DTX/DRX patterns can be implicitly mapped and represented to different network energy saving modes or with on/off pattern explicitly configured, and technically it can be also the case that each mode is associated with different spatial/power parameters. Such that, lower logical antenna port with lower number of PAs to be applied when the second apparatus 120 is going to deeper and deeper sleep mode.

Considering the logical antenna port reduction, for example, for a cell specific DTX/DRX pattern with micro sleep mode, 32-port can be applied, where for another cell specific DTX/DRX pattern with deep sleep mode the number of logical antenna port can be reduced to 4-port.

Alternatively, the antenna panel/TRP can be reduced from multiple to single, i.e., for a cell DTX/DRX pattern with micro sleep mode, multiple panel/TRP can be applied, where for another cell specific DTX/DRX pattern with deep sleep mode the number of antenna panels/TRPs is reduced to 1 or single panel/TRP.

Moreover, from power domain, the power offset configuration, i.e., powercontrolOffset and powercontrolOffsetSS, may be also adjusted accordingly. For example, the power boosting can be applied to compensate the antenna gain loss due to the loss of antenna port reduction in spatial domain.

Considering a scenario of the logical antenna port reduction, some corresponding parameters associated with the power domain may be configured as below.

For example. a size of ports for the 1^{st} DTX/DRX pattern with micro sleep mode is 64-port, and a size of ports (for energy saving muting) for the 2^{nd} DTX/DRX pattern with light sleep mode is 32-port. Furthermore, the powercontrolOffset between PDSCH and CSI-RS is configured to be −6 dB for the 1^{st} cell DTX/DRX pattern with micro sleep mode initially.

Due to port muting with reducing antenna gain, for the CSI estimation of the first apparatus 110 with the 2^{nd} cell DTX/DRX pattern with light sleep mode, the first apparatus 110 may assume the powercontrolOffset between PDSCH and CSI-RS be to OdB, which is 6 dB higher than the configured powercontrolOffset with the 1^{st} cell DTX/DRX pattern, in order to keep the same number of selected Rank Indicator (RI) as the 1^{st} cell DTX/DRX pattern case. The first apparatus 110 may feedback information of “OdB” to the second apparatus 120.

Moreover, for the subsequent transmission with the 2^{nd} cell DTX/DRX pattern, the second apparatus 120 may consider using the value of OdB for powercontrolOffset instead of original −6 dB with the 1^{st} cell DTX/DRX pattern case, to keep the same MIMO performance as the 1^{st} cell DTX/DRX pattern case transmission.

In some other example embodiments, each of the different DTX/DRX patterns may be associated with at least one CSI report configuration of the first apparatus 110.

As an option, different DTX/DRX patterns may be associated with different CSI report configurations, i.e., CSI-ReportConfig, where the first apparatus 110 may perform the CSI report differently based on the configured CSI-ReportConfig, which may be different codebookConfig configurations with corresponding different Code Book Subset Restriction (CBSR) or different numbers of logical antenna ports. For example, the first apparatus 110 may switch to the corresponding CSI reporting configuration when the cell specific DTX pattern changes.

As another option, different cell specific DTX/DRX patterns may be associated with a same/single CSI report configuration, which may also be referred as to CSI-ReportConfig, but the first apparatus 110 may perform the CSI measurements and report the CSI with one of the different numbers of logical antenna ports configured within the same CSI report configuration of the first apparatus 110, depending on the cell specific DTX/DRX pattern applied. For example, the single CSI report configuration may contain multiple configurations of different numbers of logical antenna ports, e.g., 8-port, 16- port, 24-port. One of the different numbers of logical antenna ports configured within the same CSI report configuration may be selected for CSI measurement and report.

For the single CSI-ReportConfig, the number of configured CSI-RS resource sets for channel measurement are allowed be to be more than 1, i.e., different CSI-RS resource sets corresponding to different logical antenna port muting patterns, but still keep the same number of ports for CSI-RS resources within a given CSI-RS resource set. For example, the second apparatus 120 may inform the first apparatus 110, for example, via a RRC, that resource set #a and resource set #b are configured, which correspond to different muting patterns.

Alternatively, different number of ports for CSI-RS resources configured within a given CSI-RS resource set are allowed to be configured in the single CSI-ReportConfig. By Medium Access Control (MAC)/Downlink Control Information (DCI), the second apparatus 120 may inform the first apparatus 110 on which exactly the resource/ports/resource set to measure, e.g., only the first CSI-RS resource in resource set #b to be measured by the first apparatus 110.

Furthermore, in some other example embodiments, each of the different DTX/DRX patterns or different network energy saving modes may be associated with different measurement relaxation modes to be applied at the first apparatus 110. As one option, each measurement relaxation mode corresponds to a specific relaxation scaling factor and/or the measurement period, which is determined based on the DTX/DRX patterns or the network energy saving mode. As another option, different measurement relaxation modes are associated with different logical and/or physical antenna port muting patterns of the second apparatus 120. Such adaption of measurement relaxation mode can be pre-defined or enabled/triggered by the network. The first apparatus 110 is expected to measure according to the measurement relaxation mode associated with the DTX/DRX patterns or the network energy saving mode or the antenna port muting pattern. And the measurement period or measurement requirement is also determined based on the applied measurement relaxation factor.

In the embodiments as described above, different DTX/DRX patterns may be associated with different network energy saving options applied in non-active period. As an option, the second apparatus 120 may be expected to turn off all transmission and reception for data traffic and reference signal during Cell DTX/DRX non-active periods. As another option, the second apparatus 120 is expected to turn off its transmission/reception only for data traffic during cell DTX/DRX non-active periods (i.e., the second apparatus 120 may still transmit/receive reference signals). Optionally or alternatively, the second apparatus 120 may be expected to turn off its dynamic data transmission/reception during cell DTX/DRX non-active periods (i.e., the second apparatus 120 may be expected to still perform transmission/reception in periodic resources, including SPS, CG-PUSCH, SR, RACH, and SRS. Or the second apparatus 120 may be expected to only transmit reference signals (e.g., CSI-RS for measurement) during cell DTX/DRX non-active periods.

It is to be understood that for a single cell DTX/DRX pattern, different adaptation parameters of spatial or power domain, network energy saving modes, CSI report configurations, or measurement relaxation modes, may be applied for the active/ON time and non-active/OFF time of the pattern. For example, during the network non-active/OFF time, there can be more antenna elements being switched off and only 4 ports are turned on, while during the network active/ON time, 32 ports are turned on.

Furthermore, the correspondence of different DTX/DRX patterns associated with one or more parameters for transmissions or receptions may also be used for different DTX/DRX patterns of the first apparatus 110, i.e., the UE.

With the solution, different cell DTX/DRX pattern configurations may be associated with multiple aspects of the transmission/reception of the UEs and gNBs, which may further improve the network energy saving performance.

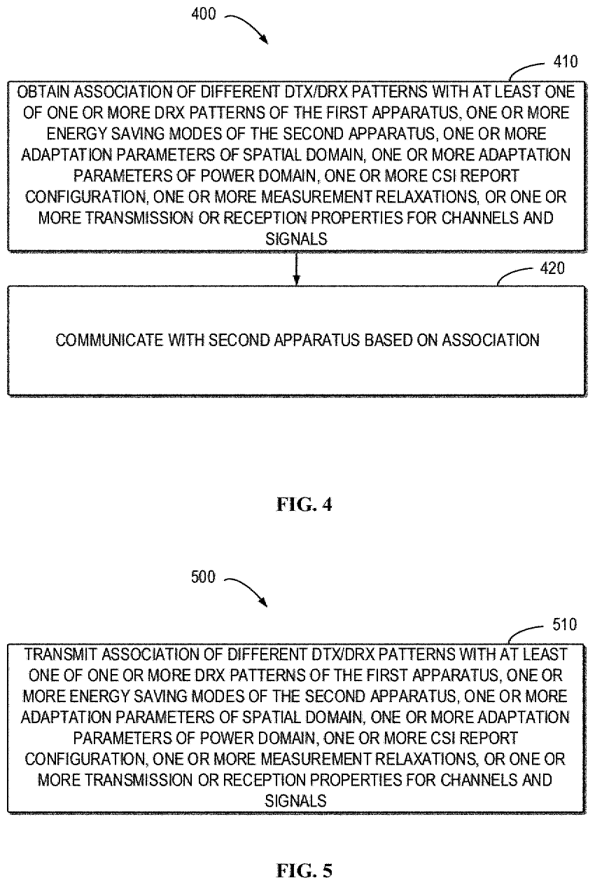

FIG. 4 shows a flowchart of an example method 400 for the network energy saving according to some example embodiments of the present disclosure. The method 400 may be implemented at the first apparatus 110 as shown in FIG. 1. For the purpose of discussion, the method 400 will be described with reference to FIG. 1.

At 410, the first apparatus 110 obtains, from a second apparatus, an association of different DTX/DRX patterns of the second apparatus with at least one of the following: one or more DRX patterns of the first apparatus, one or more energy saving modes of the second apparatus, one or more adaptation parameters of spatial domain, one or more adaptation parameters of power domain, one or more CSI report configuration, one or more measurement relaxations of the first apparatus, or one or more transmission or reception properties for channels and signals.

At 420, the first apparatus 110 communicates with the second apparatus based on the association.

In some example embodiments, the adaptation parameters of spatial domain comprise at least one of the following: the number of physical antenna ports, the number of logical antenna ports, the number of TxRUs, the number of antenna elements, the number of subarrays, the number of panels, or the number of TRPs.

In some example embodiments, the adaptation parameters of power domain comprise at least one of the following: a transmission power offset between PDSCH and CSI-RS, or a transmission power offset between CSI-RS and SSB.

In some example embodiments, in a case where the different DTX/DRX patterns are associated with different CSI report configurations, the first apparatus may switch to a CSI report configuration for performing a CSI report based on the DTX/DRX pattern to be applied.

In some example embodiments, in a case where the different DTX/DRX patterns are associated with a single CSI report configuration, the first apparatus may perform a CSI report with a set of logical antenna ports in a plurality sets of logical antenna ports configured within the single CSI report configuration.

In some example embodiments, the number of configured CSI-RS resource set for a channel state measurement is allowed to be more than one.

In some example embodiments, a plurality of CSI-RS resource sets are configured, and wherein the plurality of CSI-RS resource sets are associated with different antenna ports.

In some example embodiments, different numbers of CSI-RS resources with different antenna ports configured within a CSI-RS resource set are allowed to be configured within the single CSI report configuration.

In some example embodiments, the first apparatus may determine measurement relaxation factors for a measurement relaxation of the first apparatus based on the DTX/DRX pattern to be applied.

In some example embodiments, the energy saving modes of the second apparatus relate to different sleep modes of the second apparatus.

In some example embodiments, the different sleep modes of the second apparatus are associated with at least one of: the number of physical antenna ports allowed to be used, the number of logical antenna ports allowed to be used, the number of panels allowed to be used, the number of panels allowed to be used, the number of TRPs allowed to be used, a transmission power offset between PDSCH and CSI-RS, or a transmission power offset between CSI-RS and SSB.

In some example embodiments, the first apparatus comprises a terminal device and the second apparatus comprises a network device.

FIG. 5 shows a flowchart of an example method 500 of the network energy saving according to some example embodiments of the present disclosure. The method 500 may be implemented at the second apparatus 120 shown in FIG. 1. For the purpose of discussion, the method 500 will be described with reference to FIG. 1.

At 510, the second apparatus 120 transmit, to the first apparatus 110, an association of different DTX/DRX patterns of the second apparatus with at least one of the following: one or more DRX patterns of the first apparatus, one or more energy saving modes of the second apparatus, one or more adaptation parameters of spatial domain, one or more adaptation parameters of power domain, one or more CSI report configuration, one or more measurement relaxations of the first apparatus, or one or more transmission or reception properties for channels and signals.

In some example embodiments, the adaptation parameters of spatial domain comprise at least one of the following: the number of physical antenna ports, the number of logical antenna ports, the number of TxRUs, the number of antenna elements, the number of subarrays, the number of panels, or the number of TRPs.

In some example embodiments, the adaptation parameters of power domain comprise at least one of the following: a transmission power offset between PDSCH and CSI-RS, or a transmission power offset between CSI-RS and SSB.

In some example embodiments, in a case where the different DTX/DRX patterns are associated with a single CSI report configuration, the number of configured CSI-RS resource set for a channel state measurement is allowed to be more than one.

In some example embodiments, a plurality of CSI-RS resource sets are configured, and wherein the plurality of CSI-RS resource sets are associated with different antenna ports.

In some example embodiments, in a case where the different DTX/DRX patterns are associated with a single CSI report configuration, different numbers of CSI-RS resources with different antenna ports configured within a CSI-RS resource set are allowed to be configured within the single CSI report configuration.

In some example embodiments, the energy saving modes of the apparatus relate to different sleep modes of the apparatus.

In some example embodiments, the first apparatus comprises a terminal device and the second apparatus comprises a network device.

In some example embodiments, an apparatus capable of performing the method 400 (for example, implemented at the first apparatus 110) may include means for performing the respective steps of the method 400. The means may be implemented in any suitable form. For example, the means may be implemented in a circuitry or software module.

In some example embodiments, the apparatus comprises means for obtaining, from a second apparatus, an association of different DTX/DRX patterns of the second apparatus with at least one of the following: one or more DRX patterns of the apparatus, one or more energy saving modes of the second apparatus, one or more adaptation parameters of spatial domain, one or more adaptation parameters of power domain, one or more CSI report configuration, one or more measurement relaxations of the apparatus, or one or more transmission or reception properties for channels and signals; and means for communicating with the second apparatus based on the association.

In some example embodiments, the adaptation parameters of spatial domain comprise at least one of the following: the number of physical antenna ports, the number of logical antenna ports, the number of TxRUs, the number of antenna elements, the number of subarrays, the number of panels, or the number of TRPs.

In some example embodiments, the adaptation parameters of power domain comprise at least one of the following: a transmission power offset between PDSCH and CSI-RS, or a transmission power offset between CSI-RS and SSB.

In some example embodiments, in a case where the different DTX/DRX patterns are associated with different CSI report configurations, the apparatus may further comprise means for switching to a CSI report configuration for performing a CSI report based on the DTX/DRX pattern to be applied.

In some example embodiments, in a case where the different DTX/DRX patterns are associated with a single CSI report configuration, the apparatus may further comprise means for performing a CSI report with a set of logical antenna ports in a plurality sets of logical antenna ports configured within the single CSI report configuration.

In some example embodiments, the number of configured CSI-RS resource set for a channel state measurement is allowed to be more than one.

In some example embodiments, a plurality of CSI-RS resource sets are configured, and wherein the plurality of CSI-RS resource sets are associated with different antenna ports.

In some example embodiments, different numbers of CSI-RS resources with different antenna ports configured within a CSI-RS resource set are allowed to be configured within the single CSI report configuration.

In some example embodiments, the apparatus may further comprise means for determining measurement relaxation factors for a measurement relaxation of the first apparatus based on the DTX/DRX pattern to be applied.

In some example embodiments, the energy saving modes of the second apparatus relate to different sleep modes of the second apparatus.

In some example embodiments, the different sleep modes of the second apparatus are associated with at least one of: the number of physical antenna ports allowed to be used, the number of logical antenna ports allowed to be used, the number of panels allowed to be used, the number of panels allowed to be used, the number of TRPs allowed to be used, a transmission power offset between PDSCH and CSI-RS, or a transmission power offset between CSI-RS and SSB.

In some example embodiments, the first apparatus comprises a terminal device and the second apparatus comprises a network device.

In some example embodiments, an apparatus capable of performing the method 500 (for example, implemented at the second apparatus 120) may include means for performing the respective steps of the method 500. The means may be implemented in any suitable form. For example, the means may be implemented in a circuitry or software module.

In some example embodiments, the apparatus comprises means for means for transmitting, to a first apparatus, an association of different DTX/DRX patterns of the apparatus with at least one of the following: one or more DRX patterns of the first apparatus, one or more energy saving modes of the apparatus, one or more adaptation parameters of spatial domain, one or more adaptation parameters of power domain, one or more CSI report configuration, one or more measurement relaxations of the first apparatus, or one or more transmission or reception properties for channels and signals.

In some example embodiments, the adaptation parameters of spatial domain comprise at least one of the following: the number of physical antenna ports, the number of logical antenna ports, the number of TxRUs, the number of antenna elements, the number of subarrays, the number of panels, or the number of TRPs.

In some example embodiments, the adaptation parameters of power domain comprise at least one of the following: a transmission power offset between PDSCH and CSI-RS, or a transmission power offset between CSI-RS and SSB.

In some example embodiments, in a case where the different DTX/DRX patterns are associated with a single CSI report configuration, the number of configured CSI-RS resource set for a channel state measurement is allowed to be more than one.

In some example embodiments, a plurality of CSI-RS resource sets are configured, and wherein the plurality of CSI-RS resource sets are associated with different antenna ports.

In some example embodiments, in a case where the different DTX/DRX patterns are associated with a single CSI report configuration, different numbers of CSI-RS resources with different antenna ports configured within a CSI-RS resource set are allowed to be configured within the single CSI report configuration.

In some example embodiments, the energy saving modes of the apparatus relate to different sleep modes of the apparatus.

In some example embodiments, the first apparatus comprises a terminal device and the second apparatus comprises a network device.

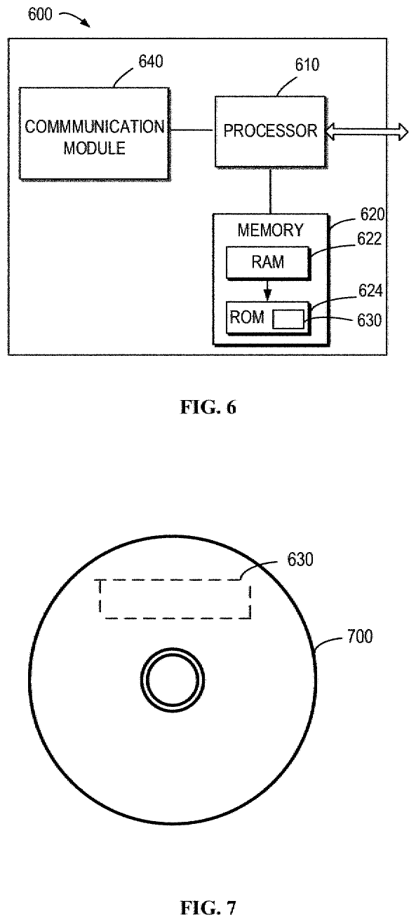

FIG. 6 is a simplified block diagram of a device 600 that is suitable for implementing example embodiments of the present disclosure. The device 600 may be provided to implement a communication device, for example, the first apparatus 110 or the second apparatus 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-25. (canceled)

26. An apparatus, comprising:
at least one processor; and
at least one memory storing instructions that, when executed by the at least one processor, cause the apparatus at least to perform:
obtaining, from a second apparatus, an association of different Discontinuous Transmission, DTX/Discontinuous Reception, DRX, patterns of the second apparatus with at least one of the following:
one or more DRX patterns of the apparatus,
one or more energy saving modes of the second apparatus,
one or more adaptation parameters of spatial domain,
one or more adaptation parameters of power domain,
one or more Channel State Information, CSI, report configuration,
one or more measurement relaxations of the apparatus, or
one or more transmission or reception properties for channels and signals; and
communicating with the second apparatus based on the association.

27. The apparatus of claim 26, wherein the adaptation parameters of spatial domain comprise at least one of the following:
the number of physical antenna ports,
the number of logical antenna ports,
the number of Transmit Receive Units, TxRUs,
the number of antenna elements,
the number of antenna subarrays,
the number of panels, or
the number of transmission and reception points, TRPs.

28. The apparatus of claim 26, wherein the adaptation parameters of power domain comprise at least one of the following:
a transmission power offset between Physical Downlink Shared Channel, PDSCH, and Channel State Information-Reference Signal, CSI-RS, or
a transmission power offset between CSI-RS and Synchronization Signal Block, SSB.

29. The apparatus of claim 26, wherein the different DTX/DRX patterns are associated with different CSI report configurations, and wherein the apparatus is further caused to perform:
switching to a CSI report configuration for performing a CSI report based on the DTX/DRX pattern to be applied.

30. The apparatus of claim 26, wherein the different DTX/DRX patterns are associated with a single CSI report configuration, and wherein the apparatus is further caused to:
perform a Channel State Information, CSI, report with a set of logical antenna ports in a plurality sets of logical antenna ports configured within the single CSI report configuration.

31. The apparatus of claim 30, wherein the number of configured CSI-Reference Signal, RS, resource set for a channel state measurement is allowed to be more than one.

32. The apparatus of claim 31, wherein a plurality of CSI-RS resource sets are configured, and wherein the plurality of CSI-RS resource sets are associated with different antenna ports.

33. The apparatus of claim 30, wherein different numbers of CSI-Reference Signal, RS, resources with different antenna ports configured within a CSI-RS resource set are allowed to be configured within the single CSI report configuration.

34. The apparatus of claim 26, wherein the apparatus is further caused to perform:
determining measurement relaxation factors for a measurement relaxation of the apparatus based on the DTX/DRX pattern to be applied.

35. The apparatus of claim 26, wherein the energy saving modes of the second apparatus relate to different sleep modes of the second apparatus.

36. The apparatus of claim 35, wherein the different sleep modes of the second apparatus are associated with at least one of:
the number of physical antenna ports allowed to be used,
the number of logical antenna ports allowed to be used,
the number of panels allowed to be used,
the number of transmission and reception points, TRPs, allowed to be used,
a transmission power offset between Physical Downlink Shared Channel, PDSCH, and Channel State Information-Reference Signal, CSI-RS, or
a transmission power offset between CSI-RS and Synchronization Signal Block, SSB.

37. The apparatus of claim 26, wherein the apparatus comprises a terminal device and the second apparatus comprises a network device.

38. An apparatus, comprising:
at least one processor; and
at least one memory storing instructions that, when executed by the at least one processor, cause the apparatus at least to perform:
transmitting, to a first apparatus, an association of different Discontinuous Transmission, DTX/Discontinuous Reception, DRX, patterns of the apparatus with at least one of the following:
one or more DRX patterns of the first apparatus,
one or more energy saving modes of the apparatus,
one or more adaptation parameters of spatial domain,
one or more adaptation parameters of power domain,
one or more Channel State Information, CSI, report configuration,
one or more measurement relaxations of the first apparatus, or
one or more transmission or reception properties for channels and signals.

39. The apparatus of claim 38, wherein the adaptation parameters of spatial domain comprise at least one of the following:
the number of physical antenna ports,
the number of logical antenna ports,
the number of Transmit Receive Units, TxRUs,
the number of antenna elements,
the number of antenna subarrays,
the number of panels, or
the number of transmission and reception points, TRPs.

40. The apparatus of claim 38, wherein the adaptation parameters of power domain comprise at least one of the following:
a transmission power offset between Physical Downlink Shared Channel, PDSCH, and Channel State Information-Reference Signal, CSI-RS, or
a transmission power offset between CSI-RS and Synchronization Signal Block, SSB.

41. The apparatus of claim 38, wherein the different DTX/DRX patterns are associated with a single CSI report configuration, and wherein the number of configured CSI-Reference Signal, RS, resource set for a channel state measurement is allowed to be more than one.

42. The first apparatus of claim 41, wherein a plurality of CSI-RS resource sets are configured, and wherein the plurality of CSI-RS resource sets are associated with different antenna ports.

43. The first apparatus of claim 38, wherein the different DTX/DRX patterns are associated with a single CSI report configuration, and wherein different numbers of CSI-Reference Signal, RS, resources with different antenna ports configured within a CSI-RS resource set are allowed to be configured within the single CSI report configuration.

44. The apparatus of claim 38, wherein the energy saving modes of the apparatus relate to different sleep modes of the apparatus.

45. A method, comprising:
obtaining, at a first apparatus and from a second apparatus, an association of different Discontinuous Transmission (DTX)/Discontinuous Reception (DRX) patterns of the second apparatus with at least one of the following: one or more DRX patterns of the first apparatus, one or more energy saving modes of the second apparatus, one or more adaptation parameters of spatial domain, one or more adaptation parameters of power domain, one or more Channel State Information (CSI) report configuration, one or more measurement relaxations of the first apparatus, or one or more transmission or reception properties for channels and signals; and
communicating with the second apparatus based on the association.
